(19) United States
(12) Patent Application Publication
(10) Pub. No.: US 2015/0104613 A1
(43) Pub. Date: Apr. 16, 2015

(54) OFFSET PRINTING FOR HIGH-SPEED CORRUGATION APPLICATIONS

(71) Applicant: Color-Box, LLC, Atlanta, GA (US)

(72) Inventors: Sergio Morales Garcia de la Vega, Johns Creek, GA (US); Alex Norman Green, Marietta, GA (US)

(21) Appl. No.: 14/483,849

(22) Filed: Sep. 11, 2014

Related U.S. Application Data
(63) Continuation of application No. 14/055,556, filed on Oct. 16, 2013.

(51) Int. Cl. B31D 1/00; B31D 99/00

(52) U.S. Cl. CPC B31D 1/0093; B31D 1/0075; B31D 99/00; B31D 2201/00
USPC 428/166; 156/277; 156/250; 156/387

(57) ABSTRACT

The present application provides systems, apparatus, and methods for providing high quality printed corrugated sheets and webs through the use of a variable sleeve offset press. In one embodiment a method is provided comprising the steps of: printing a paperboard web to provide ink to the linerboard web. The printing step may comprise using an offset printing press having variable repeat length. The method may further comprise rewinding the printed paperboard web onto a roll; providing the printed paperboard web to a high speed corrugation machine via the roll; laminating the printed paperboard web to a fluted web thereby producing a printed corrugated web. The method may further comprise applying heat to at least one of the printed paperboard web and the fluted web which causes heating of the ink on the paperboard web printed thereon by the offset printed press.

### CROSS-REFERENCE TO RELATED APPLICATION

The present patent application claims priority to U.S. patent application Ser. No. 14/055,556 filed Oct. 16, 2013, which is incorporated by reference herein in its entirety.

### BACKGROUND

The invention disclosed herein relates to methods, ink formulations, systems and apparatuses for using an offset printing press in combination with a high-speed corrugation machine.

Printed corrugated paperboard is a popular packing material for a wide variety of products. Corrugated paperboard typically comprises two or three sheets of paperboard, including a corrugated or fluted paperboard (sometimes referred to as a “medium”) and a flat paperboard (sometimes referred to as “linerboard”) laminated to one or both sides of the fluted medium. One or both of the linerboards can be printed to provide a decorative appearance to the final product, which is important in consumer-facing boxes made from corrugated paperboard.

As a result, methods of rapidly producing corrugated paperboard have been developed using the application of heat. For example, heat can be applied to the medium in order to allow the corrugation processes to run efficiently at higher speeds and to activate the starch-based adhesive used to adhere the layers together. The printed linerboards are then laminated to the fluted medium. Due to the heat used in the high speed corrugation process, care must be taken to ensure the ink on the printed linerboard is sufficiently dried and/or cured. If the ink is not sufficiently dried or cured, or if the ink is of improper formulation, the heat involved in high-speed corrugation may cause the ink to breakdown or smear, degrading the quality of the print.

Flexographic printing processes are generally used to print the linerboard for high speed corrugation applications. The relatively low viscosity ink used for flexographic printing allows the ink, and any applied coatings, the necessary time to dry and/or cure in a time frame appropriate for high speed corrugation applications. However, flexographic printing can be expensive and is usually considered to have inferior quality as compared to offset printing.

Offset, or lithographic, printing is known to be an efficient printing process in commercial applications, such as printing newspapers and books. However, offset printing has proven to be ineffective in high-speed continuous web corrugation applications where the linerboard is fed to the fluted medium. Offset printing requires a higher viscosity ink than flexographic printing, and therefore the ink and any applied coatings require longer drying times. Also, the repeat length of offset printing presses is often set and unchangeable. Thus, printing boxes of different sizes using web-fed offset printing process can be quite complicated. For printing operations where the same repeat length is used for long runs, such as paperboard for cereal boxes, this is less of an issue. However, for small print runs where color corrugated boxes are used for discrete or custom consumer uses, or low volume products, it would be advantageous to provide for high-speed, yet variable length printing processes and apparatus.

Therefore, there is a need in the art for methods, systems, and apparatus for offset printing processes for high-speed web-fed corrugation applications.

### SUMMARY

The present invention provides methods, systems, and apparatus for providing high quality printed corrugated webs, boxes, and the like. In various embodiments, a variable repeat length offset press is used to print a high quality printed paperboard. A coating and curing process may be performed to prevent degradation of the ink used to print the printed paperboard. The printed paperboard may be provided via a roll to a corrugation system, such as a high speed corrugation system. The printed paperboard may be bonded onto a fluted paperboard, a fluted paperboard on the open side of a single-faced web, and/or the like, resulting in a high quality printed corrugated web. The web may then be cut into corrugated sheets, and/or then further cut, folded and/or glued to form blanks, knock downs, and/or the like that may be formed into boxes or other products.

According to one aspect of the present invention, a method is provided for producing a high quality printed corrugated web. In various embodiments, the method comprises printing a paperboard web to provide ink to the paperboard web. The printing step may comprise using an offset press having a variable repeat length. The method may further comprise: rewinding the printed paperboard web onto a roll; providing the printed paperboard web to a high speed corrugation machine via the roll; laminating the printed paperboard web to a fluted web thereby producing a printed corrugated web. The method may further comprise applying heat to at least one of the printed paperboard web and the fluted web which causes heating of the ink on the paperboard web printed thereon by the offset printing press.

According to another aspect of the present invention, an apparatus for producing a high quality printed corrugated web is provided. In various embodiments, the apparatus may comprise a printing press component configured to provide ink to a paperboard web, thereby producing a printed paperboard web. The printing press component may be an offset printing press having a variable repeat length. The apparatus may further comprise: a winding component configured to wind the printed paperboard web onto a roll; an infeeding component configured to feed the printed paperboard web from the roll into a high speed corrugation component; and a laminating component configured to laminate the printed paperboard web onto a fluted web, thereby producing a printed corrugated web. At least one of the high speed corrugation component and the laminating component are further configured to apply heat to at least one of the printed paperboard web and the fluted web which causes heating of the ink on the paperboard web printed thereon by the printing press component.

In yet another aspect of the present invention, a high quality printed corrugated web is provided. In various embodiments, the high quality printed corrugated web is produced by printing a paperboard web to provide ink to the paperboard web. The printing step comprises using an offset printing press having a variable repeat length. The process for producing the high quality printed corrugated web may further comprise: rewinding the printed paperboard web onto a roll; providing the printed paperboard web to a high speed corrugation machine via the roll; and laminating the printed paperboard web to a fluted web thereby producing a printed corrugated web. The process of producing the high quality printed corrugated web may further comprise applying heat to at least one of the printed paperboard web and the fluted web which causes heating of the ink on the paperboard web printed thereon by the offset printing press.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic view of an offset printing system in accordance with one embodiment of the present invention;

FIG. 2 illustrates a schematic view of one embodiment of a corrugation system, in accordance with the present invention; and

FIG. 3 is a flow diagram of a method of providing high quality printed paperboard web for use in high-speed corrugation applications, in accordance with at least one embodiment of the present invention.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### Overview

The present invention provides systems, apparatus, and methods for producing high quality printed corrugated boxes. An offset printing system is used to provide a high quality printed paperboard web. In various embodiments, the offset printing system may comprise a variable sleeve offset press and may rewind the printed paperboard web onto a roll such that the printed paperboard web may be provided to a corrugation system via the roll. Providing the paperboard web to the corrugation system via a roll simplifies the time-synchronization issues provided by the speed difference between the offset printing system and the corrugation system if the offset printing system and the corrugation system were run together inline. In various embodiments, the corrugation system may be configured to provide a fluted paperboard and laminate or bond (e.g., glue, paste, and/or otherwise attach) the fluted paperboard to at least one paperboard web providing a high quality printed single-faced or single-walled corrugated web. In various embodiments, the corrugation system may comprise a high speed corrugator. Various embodiments of the invention are described below. The embodiments described herein are provided as non-limiting, illustrative examples.

### Offset Printing System 100

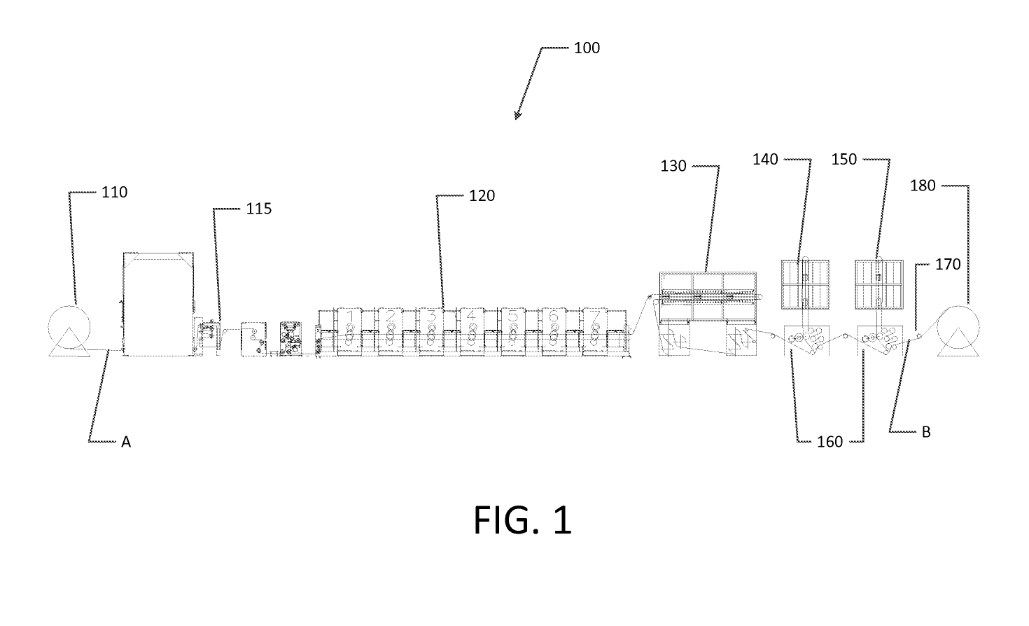

Various embodiments of the present invention comprise an offset printing system 100. FIG. 1 illustrates an example embodiment of an offset printing system 100. Starting from the left side of FIG. 1, an unprinted front paperboard web A is fed into the offset printing system 100 via web feeding device 110. In various embodiments, the front paperboard web A may be linerboard, medium, and/or the like. For example, the front paperboard web A may be a linerboard with a basis weight of approximately 23-55 pounds per 1000 square feet and a caliper of 0.007″-0.020″. In some embodiments, such as the embodiment illustrated in FIG. 1, infeed equipment 115 may be configured to control the tension in the unprinted front paperboard web A. Some embodiments may not comprise infeed equipment 115 and the tension in front paperboard web A may be controlled via other mechanisms or methods. Once the unprinted front paperboard web A is fed into offset printing system 100, the unprinted front paperboard web A is fed into an offset press 120.

In the example embodiment illustrated in FIG. 1, the offset press 120 is a variable sleeve wide-web offset press, such as the Sunday Vpak 3000 by Goss International. The variable sleeve offset press 120 allows for printing at different repeat lengths up to, for example, 55 inches. By varying the thickness of the print sleeve, the circumference of the printing cylinder may be changed, and therefore the repeat length may be changed to accommodate various printing jobs. The variable repeat length allows the same press to be used for the printing of boxes of different sizes. In the embodiment illustrated in FIG. 1, seven offset press units are used to apply ink to the front paperboard A. In various embodiments, various numbers of offset press units may be employed.

The offset press 120 may be configured to accommodate wide webs, such as webs around 75 inches in width. In various applications, wider or narrower webs may be used, as appropriate for the application. The ink used by offset press 120 may be specifically formulated to withstand the heat encountered by the printed front paperboard web B during the high-speed corrugation process.

The ink may be dried or cured onto the printed front paperboard web B in a variety of ways depending on the formulation of the ink to be used by the offset press 120. In some embodiments, the offset printing system 100 may be configured to allow the ink to dry via absorption and/or evaporation, by providing sufficient time in acceptable conditions. In various embodiments, the offset printing system 100 may comprise a curing component 130 to assist in the setting of the ink. In various embodiments, the curing component 130 may dry the ink used by the offset press 120 to print the front paperboard web B. In some embodiments, curing component 130 may aid the evaporation and/or absorption of the ink from and/or into the front paperboard web B. In other embodiments, curing component 130 may be configured to heat cure, UV cure the ink, or cure the ink by some other mechanism.

In various embodiments, the offset printing system 100 may further comprise one or more coating applicator components 160. In such embodiments, the coating applicator component 160 is configured to apply a coating to the printed front paperboard web B. In some embodiments, the applied coating may be configured to protect the ink from degradation or smearing due to the heat used in high-speed corrugation applications. In other embodiments, the applied coating may be configured to protect the printed paperboard of the finished box from visible wear. In some embodiments, the applied coating may be configured to provide the printed front paperboard web B with a semi-gloss, gloss, high gloss, or other finish. In the illustrated embodiment of FIG. 1, the first one of the coating applicator components 160 could apply an aqueous coating, and the successive coating applicator component 160 could apply a UV coating.

In embodiments of the offset printing system 100 comprising coating applicator components 160, the offset printing system 100 may further comprise coating drying components 140 and 150. In such embodiments, the coating drying components 140 and 150 may be configured to dry the coatings. In other such embodiments, the coating drying components 140 and 150 may be configured to cure the coating via heat curing, UV curing, or some other curing mechanism. In some embodiments, ink curing component 130 and coating drying components 140 and 150 may be implemented as a single component located downstream from the coating applicator component 160. Some embodiments of the offset printing system 100 may not comprise a coating drying component 140/150.

In various embodiments, such as the embodiment illustrated in FIG. 1, one or more web feeder devices may be configured to control the tension in the printed front paperboard web B as the web is fed through the offset printing system 100. In various embodiments, the web feeder device may take a variety of forms, depending on the application. After the coating drying components 140 and 150, the printed, cured, and possibly coated front paperboard web B is then fed to rewinding component 170. The rewinding component 170 is configured to roll the front paperboard web B onto roll 180 such that the front paperboard web may be easily fed into a corrugation system 200. By providing the front paperboard web B to the corrugation system 200 via a roll, rather than printing the front paperboard web B in line with the corrugation system 200, the complications of speed-synchronizing the offset printing system 100 and the corrugation system 200 may be mitigated. Speed-synchronizing the offset printing system 100 and the corrugation system 200 may be especially complicated in embodiments in which offset press 120 is a variable sleeve offset press due to the variable repeat length of the pattern printed by the variable sleeve offset press.

### Various Embodiments of Corrugation System 200

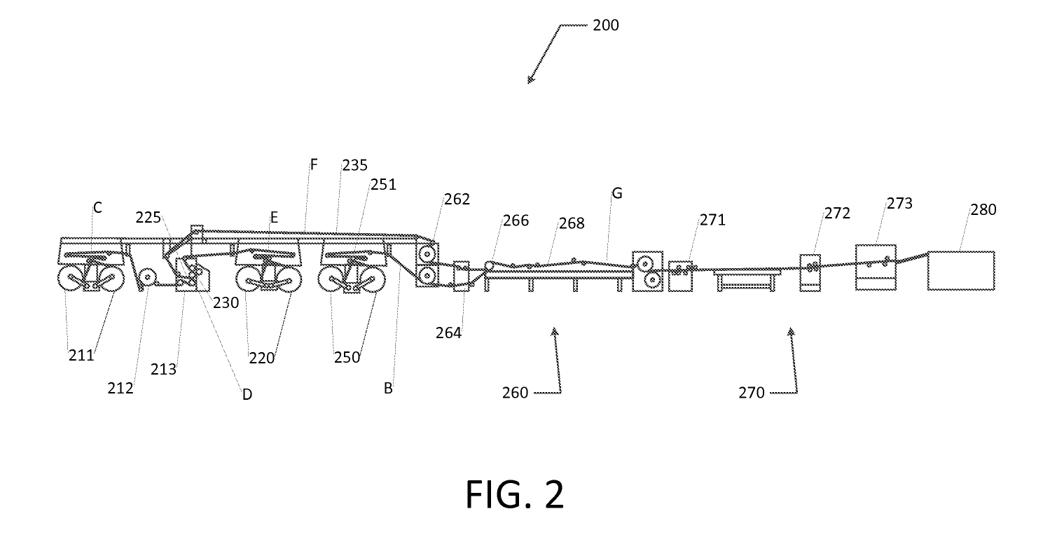

In various embodiments, a corrugation system may be configured to bond or laminate a printed paperboard B onto a fluted paperboard or the fluted paperboard on the open side of a single face web, and/or the like. The corrugation system may be configured to corrugate a paperboard web, thereby producing the fluted paperboard. In various such embodiments, the corrugation system 200 may comprise a high-speed corrugator, as is generally known in the art. The embodiment of a corrugation system 200 illustrated in FIG. 2 will now be described.

FIG. 2 shows an embodiment of a corrugation system 200 wherein the corrugation of the fluted paperboard D is completed inline. The fluted paperboard D may be any fluted paperboard appropriate for the application. The uncorrugated paperboard E is provided to the corrugation system 200 via one or more rolls loaded onto roll stand 220. The uncorrugated paperboard E may be linerboard, medium, and/or the like. For example, the uncorrugated paperboard E may be medium having a basis weight of approximately 18-42 pounds per 1000 square feet and a caliper of 0.007″-0.015″. The uncorrugated paperboard E is fed into a corrugator 213. The uncorrugated paperboard E is corrugated or fluted as it runs over the heated corrugator rolls 230, thereby producing the fluted paperboard D. The heat may be applied to the corrugator rolls 230 in any suitable form, including but not limited to the use of steam, electric resistance elements like belts or plates, or fuel combustion. In various embodiments, the corrugator rolls 230 may be heated by steam circulating through the corrugator rolls. In various embodiments, the corrugator 213 may be a high-speed corrugator. For example, the corrugator 213 may be configured to corrugate 30,000 to 72,000 feet per hour. The fluted paperboard D is then fed to the single-facing component 225, as the top paperboard web C is fed into the single-facing component 225 via one or more rolls loaded onto unwinding stand 211 and the pre-heater roller 212.

As noted, a paperboard web C is fed into the corrugation system 200 off of one or more rolls loaded onto unwinding stand 211. The paperboard web C is run over pre-heater roller 212 before being fed into the single-facing component 225. The pre-heater roller 212 may be configured to supply heat to the paperboard web C as appropriate for the application. For example, the pre-heater roller 212 may be heated via steam circulating through the pre-heater roller 212. The single-facing component 225 then laminates (also sometimes referred to as “bonds”) the paperboard web C to the fluted paperboard D, as is generally known in the art, thereby producing a single-faced web F. For example, a glue roll may apply a starch-based adhesive to the tips of the flutes of the fluted paperboard D. Suitable starch-based adhesives include those available from National Starch, Corn Products, and Carustar. A nip roller of the single-facing component 225 may then press the paperboard web C against the adhesive applied to the fluted paperboard D, causing a “green bond” to form between the paperboard web C and the fluted paperboard D, producing the single-faced web F. In various embodiments, such as that illustrated in FIG. 2, the corrugation system 200 may further comprise a bridge 235, which allows the single-faced web F to cool. In various embodiments, the bridge 235 may be configured to cool, cure, and/or dry the single-faced web F. For example, the moisture may be removed from the starch-based adhesive to strengthen the bond between the paperboard web C and the fluted paperboard D. The cooling and drying may be caused by exposure to unforced ambient air, or by way of apparatus that accelerates cooling or drying relative to ambient air. In various embodiments, the bridge 235 may also provide a mechanism by which the difference in speed between the single-facing component 225 and a double-facing component 260 may be accommodated.

Once the single-faced corrugated web F is sufficiently dry, cured, and/or cool, the single-faced corrugated web F may be fed into the double-facing component 260 via pre-heater roller 262. The pre-heater roller 262 may be configured to supply heat to the single-faced web F, as appropriate for the application. The single-faced web F may then be fed through the double-backer glue machine 264 where adhesive (e.g., a starch-based adhesive such as those discussed above) may be applied to the exposed flute tips of the single-faced web F.

In various embodiments, as the single-faced web F is fed into the double-facing component 260, the printed front paperboard web B, which was printed by the offset printing system 100, may be fed into the corrugation system 200 from one or more rolls loaded onto roll stand 250 via printed front paperboard web infeeding component 251. Particularly, the front paperboard web B may be fed into the double-facing component 260 via a pre-heater roller 262. The pre-heater roller 262 may be configured to supply heat to the printed paperboard web B as appropriate for the application. For example, the pre-heater roller 262 may be heated by steam circulating therethrough. The printed paperboard web B may then pass through the double-backer glue machine 264. In some embodiments, the double-backer glue machine 264 is configured to apply an adhesive to both the single-faced web F and the printed paperboard web B. In other embodiments, the adhesive is applied to only one of the single-faced web F and the printed paperboard web B. In various embodiments, the adhesive is a starch adhesive. The single-faced web F and the printed paperboard web B are brought into contact with each other by nip roller 266 such that the exposed flute tips of the fluted paperboard are in contact with the non-printed side of the printed paperboard web B.

The combined single-faced web F and printed paperboard web B are passed over hot plate section 268. The applied heat activates an adhesive, such as a starch-based adhesive, that is applied to the fluted paperboard. The temperature, which may be as high as 350° F., turns the adhesive into a gel consistency. The hot plate section 268 may be further configured to cure the adhesive. Thus, as the combined single-faced web F and printed paperboard web B pass over hot plate section 268, the adhesive laminates the single-faced web F to the printed paperboard web B, thereby producing a combined board web G. A combined board web having flat paperboard web bonded to only one side of the fluted paperboard web is referred to as a “single-faced” web, whereas a combined board web G having flat paperboard web bonded to both sides of the fluted paperboard web is referred to as a “single-walled” web.

As may be appreciated from the embodiment illustrated in FIG. 2, the printed paperboard web B may be fed into the corrugation system 200. In some embodiments, the printed side of the printed paperboard web B is facing downward, although other configurations could be arranged. Thus, the printed side of the printed paperboard web B may be in direct contact with the hot plates comprising the hot plate section 268. Thus, the printed side of the printed paperboard web B experiences heat and/or friction during the laminating process that may cause significant damage to the print quality of the printed paperboard web B. A coating, such as that discussed above, may be applied to the printed paperboard web B prior to supplying the printed paperboard web B to the corrugation system 200 to protect the ink printed onto the printed paperboard web B, in various embodiments.

In various embodiments, the combined board web G is fed downstream from the hot plate section 268 to the dry end 270. The dry end 270 may comprise one or more components include a rotary shear 271, a slitter/scorer 272, a knife 273 and a downstacker 280. The rotary shear 271 can cut the web in the cross-machine direction. The slitter/scorer components 271, 272 may be configured to slit the combined board web G in the direction of the advancement of the web so as to create 2, or 3 or more separate webs in the machine direction. The slitter/scorer component 272 may be further configured to score the combined board web G to facilitate later folding. The knife 273 provides a cross cutting component that may be configured to cut the combined board web G in a direction transverse to the advancement direction of the web, thereby producing sheets of combined board. Additionally, downstacker 280 may be configured to stack the sheets of combined board. Thus, in various embodiments, the dry end 270 may be configured to slit, score, and/or cut the combined board web G into sheets that are then stacked by the downstacker 280. In some embodiments, rather than being stacked as single discrete sheets, a single-walled web may be cut into lengthy strips that may be folded onto themselves in an accordion-like manner and stacked onto a pallet or the like (known as a “fanfold”), rather than being cut into individual sheets. Similarly, single-faced webs may be rolled up at rewinder rather than being stacked into individual sheets at the downstacker.

In various embodiments, the sheets of combined board G may be fed downstream to one or more converting components (not illustrated) that may, for example, receive the stacked sheets and convert them into a form that is better used for their final application. In various embodiments, the converting component may be located at a different facility than other components of the corrugation system 200. For example, in one embodiment, a converting component comprises a die cutter configured to receive the combined board sheets (i.e., sheets of combined board cut from the combined board web G). The die cutter may use a die to cut and/or score the sheets of combined board to produce blanks that could then be folded into boxes or trays, for example. In another example, a converting component comprises a flexo folder-gluer configured to receive the combined board sheets. The flexo folder-gluer may be configured to further cut, fold, and/or glue the combined board to produce knock-downs that may ultimately be formed into boxes or the like.

In various embodiments, the corrugation system may be configured to provide printed single-faced, single-walled, double-walled, or triple-walled webs, corrugated sheets, box blanks, and/or boxes. In various embodiments, one or the other or both of paperboard C and paperboard B are printed before being supplied to the corrugation system 200. To provide multi-walled corrugated sheets, box blanks, and/or boxes, additional corrugated and uncorrugated webs can be added to the construction. For example, for a double-walled construction, a second fluted paperboard may first be bonded to the first paperboard C before a second paperboard is laminated to the second fluted paperboard. However, a double-walled construction may also be formed by adding a single-facing component to the corrugation system illustrated in FIG. 2. Thus, a second paperboard may first be laminated onto a second fluted paperboard. The open side of the second fluted paperboard may then be laminated to the first paperboard C opposite the first fluted paperboard D. As another example, to provide triple-walled corrugated sheets, box blanks, and/or boxes, a third fluted paperboard may first be bonded to the second paperboard before a third paperboard is laminated to the second fluted paperboard In some embodiments, the interior and/or exterior of the resulting box may be printed. As should be understood from the disclosure herein, a variety of high quality printed corrugated boxes, box blanks, and/or sheets may be provided by various embodiments of the present invention.

### Method for Offset Printing for High-Speed Corrugation Applications

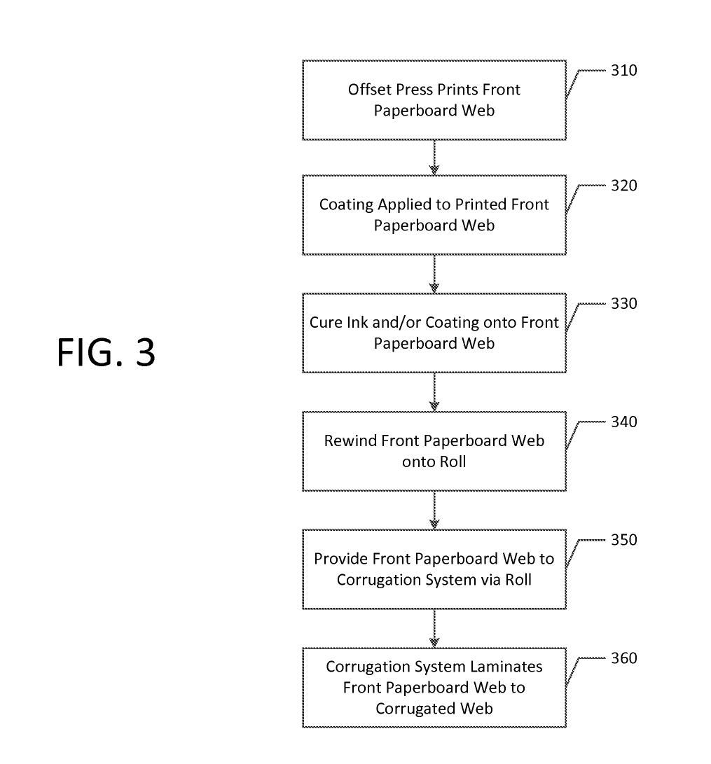

FIG. 3 is a flow diagram illustrating a method of offset printing for high-speed corrugation applications, according to various embodiments of the present invention.

At step 310 an offset printing system 100 comprising an offset press 120 is used to print the front paperboard web B. For example, the front paperboard web B may be a linerboard having a basis weight of 23 to 55 pounds per 1000 square feet. In various embodiments, the offset press may be a variable sleeve offset press. In various embodiments, the offset press may use cold set ink, heat cured ink, UV cured ink, or some other acceptable ink. The ink may be configured to not break down or smear from the heat used in the high-speed corrugation process.

At step 320 an offset printing system 100 or other system may apply a coating to the printed front paperboard web B. In various embodiments, the coating may be formulated to protect the ink used to print the front paperboard web B from degradation or smearing during the high-speed corrugation process. In other embodiments, the coating may be configured to protect the printed paperboard of the finished box from mechanical damage, such as scratching or wear. In some embodiments the coating may be used to apply a semi-gloss, gloss, high gloss, or other finish to the printed paperboard.

At step 330 the ink and/or coating are dried. In various embodiments, the step of drying the ink or coating may comprise heat curing or UV curing the ink and/or coating. In some embodiments, the ink may dry or be cured before the coating is applied.

At step 340 the printed front paperboard web B is rewound onto a roll or the like. The front paperboard web B may then be supplied to a corrugation system 200 via the roll or the like, at step 350. By providing the front paperboard web B to the corrugation system 200 via a roll or the like, the time synchronization complications caused by the difference in speed between the offset printing system 100 and the corrugation system 200 may be circumvented. The time synchronization of the offset printing system 100 and the corrugation system 200 is particularly complicated when the offset printing system 100 comprises a variable sleeve offset press due to the variable repeat length of the pattern printed by the variable sleeve offset press.

At step 360 the corrugation system 200 laminates the printed front paperboard web B onto a fluted paperboard D, producing a printed corrugated web (e.g., combined board G). The printed corrugated web may then be cut and scored to create combined board sheets, and then further converted to create blanks, knock-downs, and/or the like.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for producing a high quality printed corrugated web, the method comprising the steps of:
printing a paperboard web to provide ink to said paperboard web, wherein said printing step comprises using an offset printing press having a variable repeat length;
rewinding the printed paperboard web onto a roll;
providing the printed paperboard web to a high speed corrugation machine via the roll;
laminating the printed paperboard web to a fluted web thereby producing a printed corrugated web,
wherein the method further comprises applying heat to at least one of the printed paperboard web and the fluted web which causes heating of the ink on the paperboard web printed thereon by the offset printing press.

2. The method of claim 1 further comprising the step of curing the ink.

3. The method of claim 1 further comprising the step of applying a coating to the printed paperboard web over the ink.

4. The method of claim 3 further comprising the step of curing the coating.

5. The method of claim 1 further comprising the step of laminating a second paperboard web onto the fluted web.

6. The method of claim 1 further comprising, after the laminating step is complete, cutting the printed corrugated web into sheets.

7. The method of claim 6 further comprising converting the sheets into blanks or knock-downs.

8. The method of claim 1 wherein the ink is formulated to withstand the heating experienced by the ink due to heat applied to the fluted web during a process of corrugating the fluted web.

9. The method of claim 1 wherein the ink is formulated to withstand the heating experienced by the ink due to heat applied to at least one of the fluted web and the printed paperboard web to activate adhesive used to laminate the printed paperboard web to the fluted web.

10. The method of claim 1 wherein the offset printing press has a variable repeat length of up to 55 inches

11. The method of claim 1 wherein the offset printing press is configured to accommodate webs at least approximately 75 inches in width.

12. The method of claim 1 wherein laminating the printed paperboard web to a fluted web comprises applying an adhesive to at least one of the printed paperboard web and the fluted web, wherein the adhesive is a starch-based adhesive.

13. The method of claim 1 wherein the paperboard web is a linerboard web having a basis weight of approximately 23 to 55 pounds per 1000 square feet.

14. An apparatus for producing a high quality printed corrugated web, the apparatus comprising:
a printing press component configured to provide ink to a paperboard web, thereby producing a printed paperboard web, wherein said printing press component is an offset printing press having a variable repeat length;
a winding component configured to wind said printed paperboard web onto a roll;
an infeeding component configured to feed said printed paperboard web from said roll into a high speed corrugation component;
a laminating component configured to laminate said printed paperboard web onto a fluted web, thereby producing a printed corrugated web,
wherein at least one of the high speed corrugation component and the laminating component are further configured to apply heat to at least one of the printed paperboard web and the fluted web which causes heating of the ink on the paperboard web printed thereon by the printing press component.

15. The apparatus of claim 14 further comprising an ink curing component configured for curing said ink.

16. The apparatus of claim 15 wherein the winding component is located downstream of said ink curing component.

17. The apparatus of claim 14 further comprising a coating applicator component configured to apply a coating to said printed paperboard web over said ink.

18. The apparatus of claim 17 further comprising a coating curing component configured for curing said coating.

19. The apparatus of claim 14, wherein the printing press component configured to provide ink to a paperboard web, thereby producing a printed paperboard web, is a printing press component configured to provide ink to a linerboard web, thereby producing a printed linerboard web.

20. The apparatus of claim 14 further comprising a second laminating component configured to laminate a second paperboard web onto said fluted web.

21. The apparatus of claim 20 further comprising a printing press component configured to provide ink to the second paperboard web, thereby creating a second printed paperboard web, wherein said printing press component is an offset printing press having a variable repeat length.

22. The apparatus of claim 21 wherein the printing press component configured to provide ink to the second paperboard web, thereby producing a second printed paperboard web, is a printing press component configured to provide ink to a second linerboard web, thereby producing a second printed linerboard web.

23. The apparatus of claim 14 further comprising a cutting component located downstream of said laminating component and configured to cut said printed corrugated web into sheets.

24. The apparatus of claim 23 further comprising a converting component located downstream of said laminating component and configured to convert said sheets into individual blanks or knock-downs.

25. The apparatus of claim 14 wherein the ink is formulated to withstand the heating experienced by the ink due to heat applied to the fluted web during a process of corrugating the fluted web.

26. The apparatus of claim 14 wherein the ink is formulated to withstand the heating experienced by the ink due to heat applied to at least one of the fluted web and the printed paperboard web to activate adhesive used to laminate the printed paperboard web to the fluted web.

27. The apparatus of claim 14 wherein the offset printing press has a variable repeat length of up to 55 inches.

28. The apparatus of claim 14 wherein the offset printing press is configured to accommodate webs at least approximately 75 inches in width.

29. A high quality printed corrugated web produced by a method comprising the steps of:
printing a paperboard web to provide ink to the paperboard web, wherein said printing step comprises using an offset printing press having a variable repeat length;
rewinding the printed paperboard web onto a roll;
providing the printed paperboard web to a high speed corrugation machine via the roll;
laminating the printed paperboard web to a fluted web thereby producing a printed corrugated web,
wherein the method further comprises applying heat to at least one of the printed paperboard web and the fluted web which causes heating of the ink on the paperboard web printed thereon by the offset printing press.

30. The high quality printed corrugated web of claim 29 wherein the method of producing the high quality printed corrugated web further comprises curing the ink.

31. The high quality printed corrugated web of claim 30 wherein the method of producing the high quality printed corrugated web further comprises applying a coating to the printed paperboard web over the ink.

32. The high quality printed corrugated web of claim 31 wherein the method of producing the high quality printed corrugated web further comprises curing the coating.

33. The high quality printed corrugated web of claim 29 wherein the method of producing the high quality printed corrugated web further comprises laminating a second paperboard web onto the fluted web.

34. The high quality printed corrugated web of claim 33 further comprising the step of printing the second paperboard web to provide ink to the paperboard web, wherein said printing step comprises using an offset printing press having a variable repeat length.

35. The high quality printed corrugated web of claim 34 wherein the step of printing the second paperboard web to provide ink to the second paperboard web comprises printing a second linerboard web to provide ink to the second linerboard web.

36. The high quality printed corrugated web of claim 29 wherein the step of printing a paperboard web to provide ink to the paperboard web comprises printing a linerboard web to provide ink to the linerboard web.

37. The high quality printed corrugated web of claim 29 wherein, after the laminating step is complete, the printed corrugated web is cut into sheets.

38. The high quality printed corrugated web of claim 37 wherein the sheets are converted into individual blanks or knock-downs.

39. The high quality printed corrugated web of claim 29 wherein the ink is formulated to withstand the heating experienced by the ink due to heat applied to the fluted web during a process of corrugating the fluted web.

40. The high quality printed corrugated web of claim 29 wherein the ink is formulated to withstand the heating experienced by the ink due to heat applied to at least one of the fluted web and the printed paperboard web to activate adhesive used to laminate the printed paperboard web to the fluted web.

41. The high quality printed corrugated web of claim 29 wherein the offset printing press has a variable repeat length of up to 55 inches

42. The high quality printed corrugated web of claim 29 wherein the offset printing press is configured to accommodate webs at least approximately 75 inches in width.

43. The method of claim 5 further comprising, after the laminating step is complete, cutting the printed corrugated web into sheets.

44. The high quality printed corrugated web of claim 33 wherein, after the laminating step is complete, the printed corrugated web is cut into sheets.
